(19) United States
(12) Patent Application Publication
(10) Pub. No.: US 2010/0259041 A1
(43) Pub. Date: Oct. 14, 2010

(54) Pipe connecting structure

(76) Inventor: Jung Hui Tsan, Kaohsiung (TW)

Correspondence Address: Muncy, Geissler, Olds & Lowe, PLLC, 4000 Legato Road, Suite 310, FAIRFAX, VA, 22033, US

(21) Appl. No.: 12/081,529

(22) Filed: Apr. 17, 2008

(51) Int. Cl. F16L 25/00

(52) U.S. Cl. 285/331

(57) ABSTRACT

A pipe connecting structure has a slipping holding section having a reduced diameter on one end of a pipe, the slipping holding section has therein a connecting block provided with a screw rod of which the front end protrudes outwards; and the structure has a slipping holding hole provided on one end of another pipe in cooperation with the slipping holding section, the slipping holding hole also has therein a connecting block having a screw hole in cooperation with the screw rod of the former connecting block, thereby, when the two pipes are assembled with each other, not only the slipping holding section is slipped in the hollow slipping holding hole, but also the screw rod is screwed in the screw hole to make the two pipes be connected more firmly against dropping off, and to make the two pipes he connected easier and more convenient to make an effect of being stiffly erect against tilting after assembling, and the whole pipe connecting structure is more valuable in practical use.

### BACKGROUND OF THE INVENTION

1. Field of the Invention

The present invention relates to a pipe connecting structure, and more particularly to a brand new design of pipe connecting structure capable of connecting two pipes to render the latter not only firmer against dropping, but also easier and more convenient for connecting, and to render the latter more stiffly erect, and the whole pipe connecting structure is more valuable in practical use.

2. Description of the Prior Art

In various utensils in our daily life, we can often see various pipes are used as supports or handles; in order for packing, storage and for being easier and more convenient for people to purchase, pipes are often composed of plural sections which are connected with one another when in use.

In the pipes, as shown in the schematic sectional view in FIG. 4 is a structure for one of conventional pipe structures. The structure is mainly provided on one end of a pipe 51 with a connecting block 52, the connecting block 52 is provided with a screw rod 521 protruding outwards; and it is provided on one end of another pipe 53 with a connecting block 54, the connecting block 54 in cooperation with the screw rod 521 is provided with a screw hole 541, thereby the screw rod 521 on the connecting block 52 of the pipe 51 can be screwed in the screw hole 541 in the connecting block 54 of the pipe 53 to make connection between and positioning of the two pipes 51, 53.

However, although the above stated pipe connecting structure can have an expected effect of making connecting of two pipes by screwing in, in practical operation and use, it is found that the structure only makes connecting of the two pipes by screwing a screw rod in a screw hole; such connection mode is a one spot connection, after connecting of the two pipes, there will be a situation of tilting occurring at the connecting spot, and meantime, the strength of connecting of the two pipes is inadequate. Correspondingly, the force of supporting is inadequate. Such a structure is extremely subject to breaking at the connecting spot between the two pipes, and thereby there is a room for improvement.

And in the pipes, as shown in the schematic sectional view in FIG. 5 which is another structure of conventional pipes. It is mainly provided on one end of a pipe 61 with a hollow slipping holding hole 611, and provided on one end of another pipe 62 with a slipping holding section 621 having a reduced diameter, the slipping holding section 621 can be tightly inserted in the hollow slipping holding bole 611 to thereby make connection between and positioning of the two pipes 61, 62.

Still the above stated pipe connecting structure can also have an expected effect of making connecting of two pipes by slipping connecting, in practical operation and use, it is found that the structure makes connecting of the two pipes by tightly slipping holding of the hollow slipping holding hole with the slipping holding section, thereby the sizes of the hollow slipping holding hole and the slipping holding section have to tightly match with each other. When such slipping connecting is overly loose, the slipping holding section is subject to being dropped off from the hollow slipping holding hole; and when such slipping connecting is overly tight, the slipping holding section is unable to be slipped in the hollow slipping holding hole smoothly to thereby result extremely inconvenient assembling. Thus, this mode of slipping connecting is left a room for improvement also.

Therefore, in view of the above, the inventor of the present invention hereby provides an improved pipe connecting structure against the conventional structures and their defects based on his experience in designing, developing and practical manufacturing of years of the related trade, for the purpose of reaching an object of getting better practical industrial value.

### SUMMARY OF THE INVENTION

The pipe connecting structure of the present invention mainly has a slipping holding section having a reduced diameter on one end of a pipe, the slipping holding section is provided therein with a connecting block provided with a screw rod of which the front end protrudes outwards; and the pipe connecting structure has a slipping holding hole provided on one end of another pipe in cooperation with the slipping holding section. The slipping holding hole is also provided therein with a connecting block having a screw hole in cooperation with the screw rod of the former connecting block, thereby, when the two pipes are assembled with each other, not only the slipping holding section can be slipped in the hollow slipping holding hole, but also the screw rod can be screwed in the screw hole to make the two pipes be connected more firmly against dropping off, thus to make the two pipes be connected easier and more convenient, and more stiffly erect against tilting after assembling. The whole pipe connecting structure is more valuable in practical use.

The present invention will be apparent in its content, objects of invention and effects after reading the detailed description of the preferred embodiment thereof in reference to the accompanying drawings.

### BRIEF DESCRIPTION OF THE DRAWINGS

FIG. 1 is an exposed schematic perspective view of the present invention;

FIG. 2 is a schematic sectional view showing the structure of the present invention;

FIG. 3 is a schematic sectional view showing the structure of the present invention after assembling;

FIG. 4 is a schematic sectional view showing a conventional structure;

FIG. 5 is a schematic sectional view showing another conventional structure.

### DETAILED DESCRIPTION OF THE PREFERRED EMBODIMENT

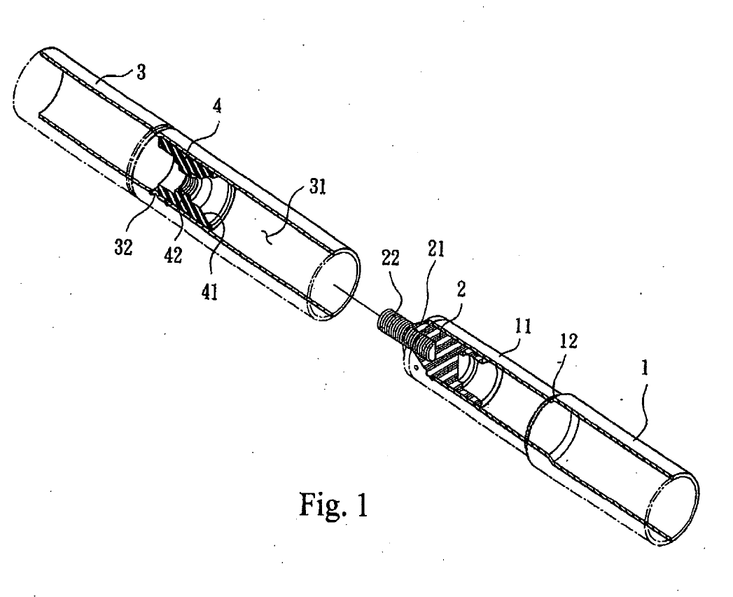

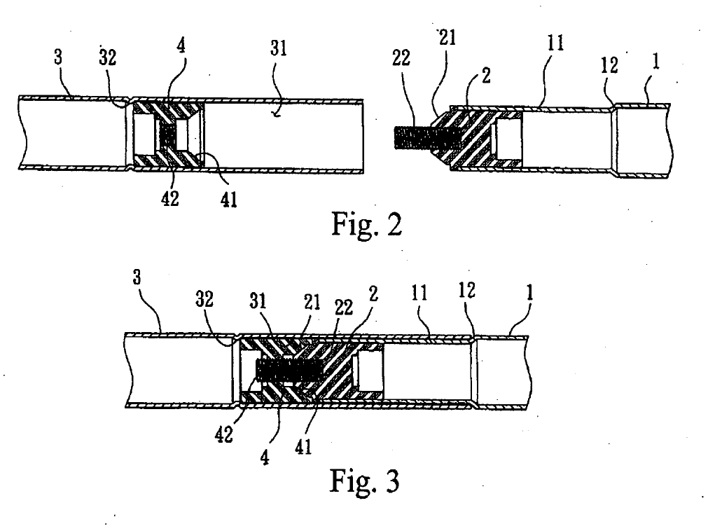

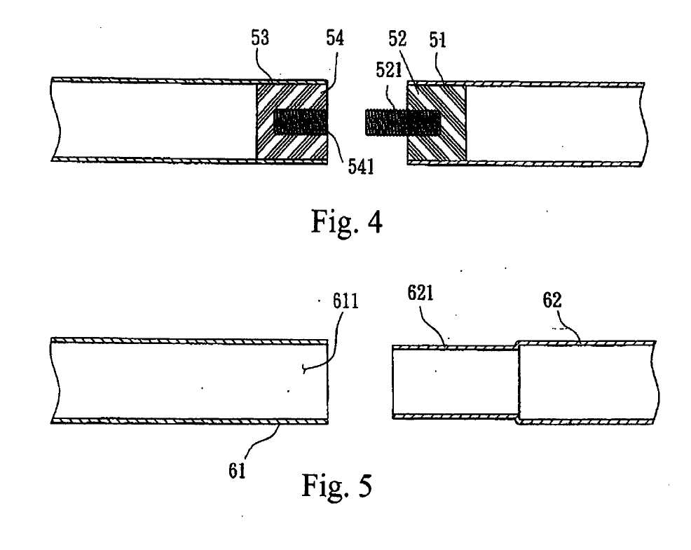

Referring to FIGS. 1 and 2 respectively show an exposed schematic perspective view and a schematic sectional view both showing the structure of the present invention. The present invention is provided mainly on one end of a pipe 1 with a slipping holding section 11 having a reduced diameter, a tapered tightly fitting portion 12 is formed at the connecting area of the pipe 1 with the slipping holding section 11, the slipping holding section 11 is provided at its front end with a connecting block 2, the outer end of the connecting block 2 is formed a conical slipping-in connecting portion 21, and meantime the front end of the conical slipping-in connecting portion 21 is provided with a screw rod 22 protruding outwards. And it is provided on one end of another pipe 3 with a slipping holding hole 31 in cooperation with the slipping holding section 11, the slipping holding hole 31 is also provided therein with a connecting block 4 further, the slipping holding hole 31 of the pipe 3 is formed therein a limiting portion 32 for limiting the position of the connecting block 4, the conical slipping-in connecting portion 21 of the connecting block 2 in matching with a slipping connecting hole 41 in the shape of a concave conic which is provided therein the connecting block 4, and the screw rod 22 protruding outwards of the front end of the conical slipping-in connecting portion 21 of the connecting block 2 is matching with a screw hole 42 which is provided therein the slipping connecting hole 41.

In this case, and referring together to FIG. 3 which is a schematic sectional view showing the structure of the present invention after assembling, we can see that when the two pipes 1, 3 are to be connected with each other, the slipping holding section 11 of the pipe 1 is inserted in the slipping holding hole 31 of the pipe 3, and meantime the connecting block 2 provided at the front end of the slipping holding section 11 has its screw rod 22 protruding outwards inserted in the screw hole 42 of the connecting block 4 in the slipping holding hole 31; at this time, the conical slipping-in connecting portion 21 of the connecting block 2 is inserted in the slipping connecting hole 41 of the connecting block 4 to make an effect of supporting and positioning. After tight connecting by screwing in the screw rod 22 into the screw hole 42, an inner edge at the front end of the slipping holding hole 31 of the pipe 3 is exactly slipped over the tapered tightly fitting portion 12 formed at the connecting area of the pipe 1 and the slipping holding section 11 to form a tightly fitting state, so that the two pipes 1, 3 obtain the effect and object of tightly fitting against shaking.

As stated above, from the composition of elements and the way of applying as described above for the embodiment, we can see that the present invention, in comparison with the conventional structures, has two pipes insertion connected by a slipping holding section with a slipping holding hole, and has connecting blocks respectively provided in the slipping holding section and the slipping holding hole, the connecting blocks respectively have a screw rod and a screw hole for connecting the two pipes by screw connecting, thereby, when the two pipes are assembled with each other, not only connecting of the two pipes can be firmer against dropping, but also the two pipes are connected easier and more convenient, and more stiffly erect against tilting after assembling, and in applying, the whole pipe connecting structure is more valuable practically.

In conclusion, the present invention surely can achieve its expected objects in application; the particular structure disclosed in it has never existed in similar products and has never been published before patent application. The above stated embodiment and drawings are not for giving any limitation to the scope of the present invention. Thus, we remain grateful and kindly ask the patent be examined and granted on the basis of the following claims.

1. A pipe connecting structure, said structure mainly has a pipe provided on one end thereof with a slipping holding section, said slipping holding section is provided at its front end with a connecting block being provided with a screw rod of which a front end protrudes outwards; and said structure has a slipping holding hole provided on one end of another pipe in cooperation with said slipping holding section, said slipping holding hole is also provided therein with a connecting block having a screw hole in cooperation with said screw rod.

2. The pipe connecting structure as stated in claim 1, wherein said slipping holding section on one end of said first mentioned pipe has a reduced diameter.

3. The pipe connecting structure as stated in claim 1, wherein a tapered tightly fitting portion is formed at a connecting area of said first mentioned pipe with said slipping holding section.

4. The pipe connecting structure as stated in claim 1, wherein said connecting blocks are provided respectively with a conical slipping-in connecting portion and a slipping holding hole in cooperation with each other.
